(19) United States
(12) Patent Application Publication
(10) Pub. No.: US 2023/0044792 A1
(43) Pub. Date: Feb. 9, 2023

(54) SYSTEM AND METHOD FOR ENGAGING AN ONLINE GROUP DURING AN ENTIRE GROUP LIFECYCLE

(71) Applicant: K Israel Rajakumar, Bangalore (IN)

(72) Inventor: K Israel Rajakumar, Bangalore (IN)

(21) Appl. No.: 17/809,002

(22) Filed: Jun. 26, 2022

(30) Foreign Application Priority Data
Jul. 21, 2021 (IN) 202141032729

(51) Int. Cl. H04L 51/224; G06F 3/04847; H04L 67/75; H04L 51/56

(52) U.S. Cl. CPC H04L 51/224; G06F 3/04847; H04L 67/75; H04L 51/56

(57) ABSTRACT

There is provided a method for engaging an online group during an entire group lifecycle using a group activity server that is communicatively connected with user devices associated with users. The method includes (i) obtaining a first input associated with a group activity for a group from a first user device associated with a first user, (ii) obtaining a group activity tool template from a group activity tool template repository, and (iii) generating a GAT based on obtained GAT template and the first input, (iv) creating a first notification badge, and a second notification badge on the generated GAT, and (v) incorporating the generated GAT in user interfaces of the user devices associated with the members of the group to enable members of the group to participate in the generated GAT, thereby engaging the members of the group during the entire group lifecycle.

### CROSS-REFERENCE TO PRIOR-FILED PATENT APPLICATIONS

This application claims priority from the Indian provisional application no. 202141032729 filed on Jul. 21, 2021, which is herein incorporated by reference.

### TECHNICAL FIELD

The embodiments herein generally relate to an online group management during an entire group lifecycle using a group activity server, and in particular, creating a group activity tool for effective online group engagement.

### DESCRIPTION OF THE RELATED ART

The world wide web has become an important medium for electronic communication. Further, participation in online groups constitutes a significant part of online communication. In addition to facilitating discussions and comments, online groups are increasingly being used in a variety of settings like psychotherapy, education, e-commerce, etc. While the current group engagements are enabled through a simple browser and mobile interfaces, there is a high probability that they will incorporate emerging technologies like virtual reality (VR) and augmented reality (AR) in the near future.

One of the major problems with online messaging is the management of online groups. The usability of an online group, especially the management aspect has become a tedious task because of the inefficiency of the interface. An existing interface presents only a single stream of posts or comments.

Additionally, due to a lack of an effective method to control and manage group communication, the messages sent by group administrators are usually buried under a heap of messages/comments posted by users or members of the group.

Further existing technology requires the users of the group to visit an external website or application to complete any required action, such as completing a questionnaire or voting in a poll. The online chat interface simply provides a place to post a link for the required action. Calendar, messaging, participating in polls, answering a questionnaire, and other web-based services as such are considered to be separate and distinct. The aforementioned web services, therefore, are not designed to efficiently work in an integrated manner. The need to access different web-based services, typically not in a user-friendly manner, hampers the overall communication between the group of participants.

Therefore, there arises a need to address the aforementioned technical drawbacks in a better way for effective online group engagement.

### SUMMARY

In view of the foregoing, an embodiment herein provides a processor-implemented method for engaging an online group during an entire group lifecycle using a group activity server that is communicatively connected with user devices associated with users. The method includes (i) obtaining a first input associated with at least one group activity for at least one group from a first user device associated with a first user, the first input includes at least one parameter related to the at least one group activity, (ii) obtaining a group activity tool (GAT) template from a group activity tool template repository for the at least one group based on obtained first input, the group activity tool template repository includes one or more GAT templates, (iii) generating a GAT based on obtained GAT template and the first input, (iv) creating a first notification badge, and a second notification badge on the generated GAT for the at least one group, and (v) incorporating the generated GAT in user interfaces of the user devices associated with members of the at least one group to enable the members of the at least one group to participate in the at least one group activity via the generated GAT, thereby engaging the members of the at least one group during the entire group lifecycle. The first notification badge indicates when at least one action related to the at least one group activity is pending from the at least one group of the first user. The second notification badge indicates when at least one information is sent by at least one group member of the at least one group.

In some embodiments, the method further includes (i) obtaining the first input from the first user through a first interface of the first user device, the first input includes information to create a group, to close a group, to create a GAT, or to create broadcast messages, and (ii) creating the at least one group based on the first input that includes a plurality of parameters. The plurality of parameters may include at least one of a group title, a group description, a group template identity, or a unique group identity.

In some embodiments, the method includes providing a separate interface for the first user to communicate with the at least one group by creating messages and broadcasting the messages in the separate interface, thereby separating the messages of the first user from other members of the at least one group to improve communication within the at least one group.

In some embodiments, the generated GAT includes at least one of group rules for the members, a link for an upcoming meeting, at least one of a poll for participation, instructions to upload a media content, or a questionnaire for participation.

In some embodiments, the first notification badge and the second notification badge are color-coded for easy identification. The first notification badge and the second notification badge may comprise a count of items in the generated GAT.

In some embodiments, the first notification badge and the second notification badge are displayed simultaneously with respective due dates for completing the at least one group activity. The color-coding of the first notification badge and the second notification badge may change based on the respective due dates.

In one aspect, there is provided one or more non-transitory computer-readable storage mediums storing the one or more sequences of instructions, which when executed by the one or more processors, causes to perform a method for engaging an online group during an entire group lifecycle using a group activity server that is communicatively connected with user devices associated with users group lifecycle. The method includes (i) obtaining a first input associated with at least one group activity for at least one group from a first user device associated with a first user, the first input includes at least one parameter related to the at least one group activity, (ii) obtaining a group activity tool (GAT) template from a group activity tool template repository for the at least one group based on obtained first input, the group activity tool template repository includes one or more GAT templates, (iii) generating a GAT based on obtained GAT template and the first input, (iv) creating a first notification badge, and a second notification badge on the generated GAT for the at least one group, and (v) incorporating the generated GAT in user interfaces of the user devices associated with members of the at least one group to enable the members of the at least one group to participate in the at least one group activity via the generated GAT, thereby engaging the members of the at least one group during the entire group lifecycle. The first notification badge indicates when at least one action related to the at least one group activity is pending from the at least one group of the first user. The second notification badge indicates when at least one information is sent by at least one group member of the at least one group.

In another aspect, there is provided a system for engaging an online group during an entire group lifecycle using a group activity server that is communicatively connected with user devices associated with users. The system includes one or more user devices and a group activity server that is communicatively connected with the one or more user devices. The group activity server includes a memory that stores a database and a set of modules, a processor in communication with the memory. The processor retrieves executing machine-readable program instructions from the memory which, when executed by the processor, enable the processor to (i) obtain a first input associated with at least one group activity for at least one group from a first user device associated with a first user, the first input includes at least one parameter related to the at least one group activity, (ii) obtain a group activity tool (GAT) template from a group activity tool template repository for the at least one group based on obtained first input, the group activity tool template repository includes one or more GAT templates, (iii) generate a group activity tool (GAT) based on obtained GAT template and the first input, (iv) create a first notification badge, and a second notification badge on the generated GAT for the at least one group, and (iv) incorporate the generated GAT in user interfaces of the user devices associated with members of the at least one group to enable the members of the at least one group to participate in the at least one group activity via the at least one of the generated GAT, thereby engaging the members of the at least one group during the entire group lifecycle. The first notification badge indicates when at least one action related to the at least one group activity is pending from the at least one group of the first user. The second notification badge indicates when at least one information is sent by at least one group member of the at least one group.

In some embodiments, the processor is configured to (i) obtain the first input from the first user through a first interface of the first user device the first input includes information to create a group, to close a group, to create a GAT, or to create broadcast messages, and (ii) creating the at least one group from the group template repository based on the first input that includes a plurality of parameters. The plurality of parameters may include at least one of a group title, a group description, a group template identity, or a unique group identity.

In some embodiments, the processor is configured to provide a separate interface for the first user to communicate with the at least one group by creating messages and broadcasting the messages in the separate interface, thereby separating the messages of the first user from other members of the at least one group to improve communication within the at least one group.

In some embodiments, the generated GAT includes at least one of group rules for the members, a link for an upcoming meeting, at least one of a poll for participation, instructions to upload a media content, or questionnaire for participation.

In some embodiments, the first notification badge and the second notification badge are color-coded for easy identification. The first notification badge and the second notification badge may comprise a count of items in the generated GAT.

In some embodiments, the first notification badge and the second notification badge are displayed simultaneously with respective due dates for completing the at least one group activity. The color-coding of the first notification badge and the second notification badge may change based on the respective due dates.

The system and/or method is used for decluttering group interface to streamline the group interactions. Additionally, a separate interface is available to the first users (e.g., group administrator) to create and send broadcast messages, improving the communication within the group. The system or method may expedite the process of polling and reach out to group members without any unwanted message posting.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a block diagram of a system for engaging an online group during an entire group lifecycle, according to some embodiments herein;

FIG. 2 illustrates a block diagram of a group activity server of FIG. 1, according to some embodiments herein;

FIG. 3 illustrates a block diagram of a group activity tool module of FIG. 2, according to some embodiments herein;

FIG. 4 illustrates an exemplary user interface of a user device for a created group, according to some embodiments herein;

FIG. 5 illustrates a method for engaging an online group during an entire group lifecycle, according to some embodiments herein; and

FIG. 6 is a schematic diagram of a computer architecture of a system or a group activity server or a user device or any computing device for effective online group engagement, in accordance with the embodiments herein.

### DETAILED DESCRIPTION OF THE DRAWINGS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

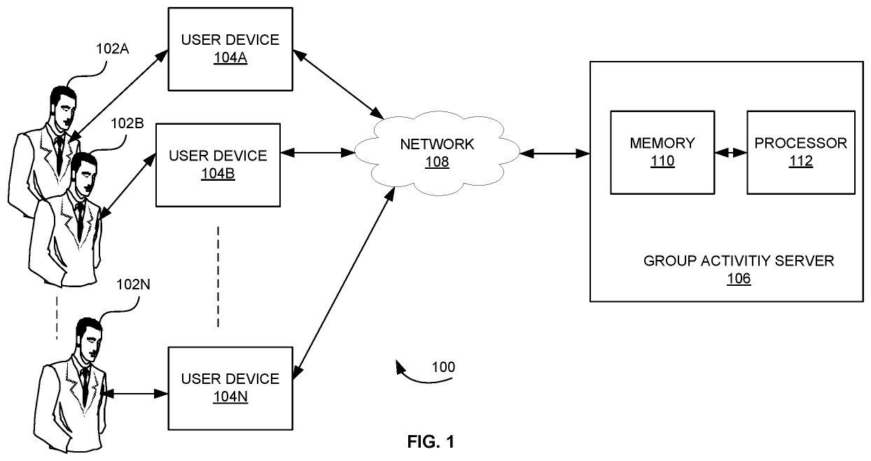

As mentioned, there remains a need for a system and a method for engaging an online group during an entire group lifecycle using a group activity server that is communicatively connected with user devices associated with users, that can overcome the existing drawbacks. Referring now to the drawings, and more particularly to FIGS. 1 through 6, where similar reference characters denote corresponding features consistently throughout the figures, preferred embodiments are shown.

FIG. 1 illustrates a block diagram of a system 100 for engaging an online group during an entire group lifecycle, according to some embodiments herein. The system 100 effectively engages an online group in a group activity during an entire group lifecycle. The system 100 includes one or more user devices 104A-N associated with one or more users 102A-N, and a group activity server 106. The group activity server 106 interactively communicates with the one or more user devices 104A-N via a network 108. The network 108 includes, but is not limited to, a wireless network, a wired network, a combination of the wired network and the wireless network or Internet, Bluetooth, Wi-Fi, ZigBee, cloud, or any other communication network. The group activity server 106 includes a memory 110 that stores a set of instructions/modules and a database and a processor 112 that is configured to execute the set of instructions to perform one or more actions associated with the group activity server 106.

A first user 102A may be a group administrator. The group administrator may have a privilege to create a group or an appropriate group activity tool (GAT) during the entire group lifecycle to achieve intended outcomes. The one or more users 102A-N may perform one or more actions in the group-based user privileges that are defined for the one or more users 102A-N. The one or more users 102A-N may use one of, but not limited to, a keyboard, a touch pad, a touch pen, a smart device, voice input, voice recorder, a video, hand, or digital device gesture, augmented reality (AR), virtual reality (VR) and so on to perform one or more actions associated the one or more user devices 104A-N. The one or more actions may include, but are not limited to, providing input to the group activity server 106, sending messages to the group, participating in the group activity, and the like. The first user device 104A includes a first interface to interact with the group. In some embodiments, the one or more user devices 104A-N includes, but is not limited to, a handheld device, a mobile phone, a Personal Digital Assistant (PDA), a tablet, a laptop, a computer, an electronic notebook, or a smartphone and the like.

The group activity server 106 obtains a first input from a first user device 104A associated with a first user 102A. The group activity server 106 obtains the first input from the first user through a first interface of the first user device 104A. The first input may comprise information to create a group, to close a group, to create a group activity tool (GAT), or to broadcast messages. The group activity server 106 creates the group based on the first input that comprises information to create the group. The information to create the group may include one or more parameters. The one or more parameters may include at least one of a group title, a group description, a group template identity, or a unique group identity. The group activity server 106 obtains a group activity tool (GAT) template from a group activity tool template repository for the at least one group based on obtained first input that includes the information to create the GAT. The information to create the GAT comprises at least one parameter related to the at least one group activity. In some embodiments, the group activity tool template repository includes one or more GAT templates. The group activity server 106 generates a group activity tool (GAT) based on obtained GAT template and the first input that includes the information to create the GAT. For example, the GAT may be generated using android studio. In some embodiments, the generated GAT includes group rules for the one or more users 102A-N, a link for an upcoming meeting, a poll for participation, uploading a video, or a questionnaire for participation. The group activity server 106 creates a first notification badge and a second notification badge on the generated GAT for the group. The first notification badge indicates when at least one action related to the at least one group activity is pending from at least one group of the first user 102A. The second notification badge indicates when at least one information is sent by at least one group or at least one group member of the group. The first notification badge and the second notification badge are color-coded for easy identification. The first notification badge and the second notification badge may include a count of items in the generated GAT. In some embodiments, the first notification badge and the second notification badge are displayed simultaneously with respective due dates for completing the at least one group activity. The color-coding of the first notification badge and the second notification badge may change based on the respective due dates.

The group activity server 106 incorporates the generated GAT in user interfaces of the one or more user devices 104A-N associated with the one or more users 102A-N of the group to enable members of the group to participate in at least one of the generated GAT, thereby engaging the members of the group during the entire group lifecycle. The one or more users 102A-N may be one or more members of the group. The system 100 according to the present disclosure is of advantage in that the system 100 organizes group activities in separate group activity tools, thereby enabling effective group engagement. The group activity server 106 isolates or separates information items (such as messages) from the group activity in the GAT, thus clearly separating chat and comments from the group activity that needs to be performed by the group members. This helps in decluttering the group interface. Further, the group activity server 106 enables to capture of different action responses like gestures, video, audio, etc. The group activity server 106 enables members of the group to identify and respond to the group activity by providing separate GAT for each group activity.

In some embodiments, the members of the group respond to at least one group activity or send messages in augmented reality (AR) or virtual reality (VR) by capturing different action responses. The different action responses may be gestures, video, or audio.

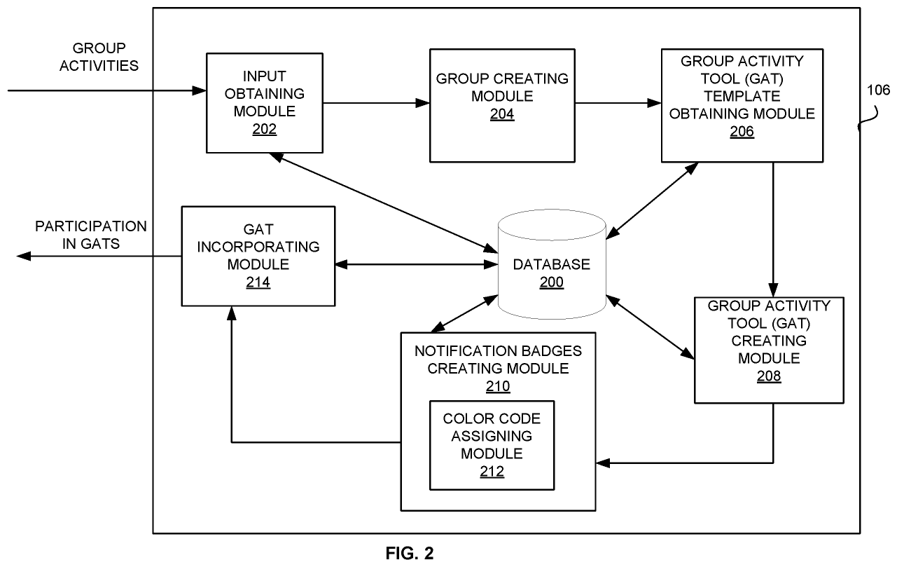

FIG. 2 illustrates a block diagram of a group activity server 106 of FIG. 1, according to an embodiment herein. The group activity server 106 includes an input obtaining module 202, a group creating module 204, a group activity tool (GAT) template obtaining module 206, a group activity tool (GAT) creating module 208, a notification badges creating module 210, a color-code assigning module 212, a GAT incorporating module 214, and a database 200. The database 200 may be communicatively connected to one or more modules of the group activity server 106. The database 200 may include one or more GAT templates.

The input obtaining module 202 obtains a first input from a first user device 104A associated with a first user 102A. The first input may comprise information to create a group, to close a group, to create a group activity tool (GAT), or to broadcast messages. The information to create the GAT comprises at least one parameter related to the at least one group activity.

The group creating module 204 creates the group based on the first input that comprises information to create the group providing the information to create the group may include one or more parameters. The one or more parameters may include at least one of a group title, a group description, a group template identity, or a unique group identity. The first user 102A may define a purpose of the group, a number of users in the group, and the group activity. For example, the first user 102A creates a group for a depression treatment that relates to a healthcare domain.

The group activity tool (GAT) template obtaining module 206 obtains a GAT template based on the first input from the GAT template repository or the database 200. For example, the group activity tool (GAT) template obtaining module 206 obtains a GAT template that is related to the healthcare domain if the first input comprises group activity information related to the depression treatment. The group that is created by the first user 102A is managed by at least one activity that takes place in the group. For example, the group activities in the created group by the first user 102A may be managing the number of users in a group, polling activity for the users, meeting schedules, uploading or downloading any multimedia file, and so on. Upon completion of the purpose for the group, the first user 102A may close the group. In an embodiment, the application programming interface (API) is used for all modules in creating the group, managing the group, and closing the group based on the selected group template. In an embodiment, for management purposes, the first user 102A is allowed to add or remove any user at any given time from the group and or close the group completely. The GAT creating module 208 generates a group activity tool (GAT) based on selected the group activity tool template and the first input. In some embodiments, the GAT includes the application programming interface (API) is used for all actions of the group activity tool creating module 208.

Upon instantiation of one or more group activity tools, the notification badges creating module 210 creates a first notification badge and a second notification badge for the generated GAT of the group. The first notification badge indicates when at least one action is pending from at least one group of the first user 102A and the second notification badge indicates when at least one information is sent by at least one group or at least one group member from the first user 102A. The first notification badge and the second notification badge are color-coded for easy identification. The count of notification items in the group activity tool may be recorded in the database 200. In an embodiment, at any given time, both the first notification badge and the second notification badge on the generated group activity tools may be displayed simultaneously. The color-code assigning module 212 assigns color-codes for the first notification badge and the second notification badge for easy identification. The first notification badge and the second notification badge may comprise a count of items in the generated GAT. The GAT incorporating module 214 incorporates the generated GAT in user interfaces of the one or more user devices 104A-N associated with the one or more users 102A-N of the group to enable members of the group to participate in at least one of the generated GAT, thereby engaging the members of the group during the entire group lifecycle.

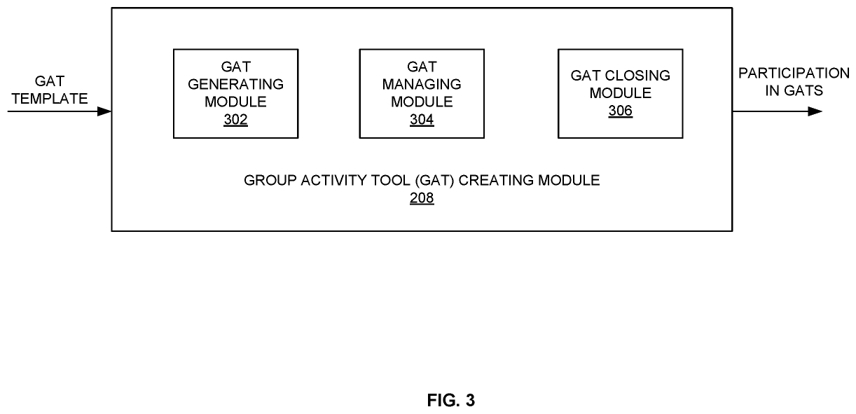

FIG. 3 illustrates a block diagram of a group activity tool creating module 208 of FIG. 2, according to some embodiments herein. The block diagram of the group activity tool creating module 208 includes a GAT (group activity tool) generating module 302, a GAT managing module 304, and a GAT closing module 306. The GAT generating module 302 generates a group activity tool (GAT) based on a requirement of the first user 102A. The GAT is generated based on the selected a GAT template from the group activity template repository and the requirement of the first user 102A. In an embodiment, the application programming interface (API) is used for all modules in group activity tool creating module 208 such as the GAT generating module 302, the GAT managing module 304, and the GAT closing module 306. To create one or more group activity tools in the GAT generating module 302, the first input parameters include unique group ID, GAT template ID, and unique GAT ID. In an embodiment, the API call used by the GAT generating module 302 is a representational state transfer (REST) API. Optionally, the REST API is particularly beneficial for cloud-based services and for users seeking to perform a certain set of actions and requiring a list of results in return. In an embodiment, the first user 102A may create a request in the form of an URL to perform an action and the REST API may provide data for it as a response. For example, the first user 102A may request user information on a webpage, and the response from the other users is obtained as data through the REST API processed on the webpage. The REST API may be used to extract the data from the webpage where the responses of the users are captured. The request may be modified by key-value pairs by modifying query parameters. The REST API may provide security by performing authorization checks to ensure the identity of the first user 102A and second user 102B. The authorization checks enable the first user 102A actions only to be limited to the first user 102A, thereby avoiding the risk of first user actions being performed by other users. The one or more GATs may be an active group activity tool or closed group activity tool depending on the action required to be performed by the group activity server 106. The GAT managing module 304 manages one or more group activity tools. In some embodiments, the GATs show information or enable an action. For example, in the case of poll GATs, the GAT enables the user to perform the action like participating in the poll. In an embodiment, the group activity tools that show information include, but are not limited to, group rules for users, a link for an upcoming meeting, and so on. In an embodiment, the group activity tools that enable action include, but are not limited to creating and completing a poll, uploading a video, creating and completing a questionnaire, and so on. The group activity server 106 on receiving a request from the first user 102A, the GAT closing module 308 closes the group for all the users. In some embodiments, the group remains active even if the GAT is closed.

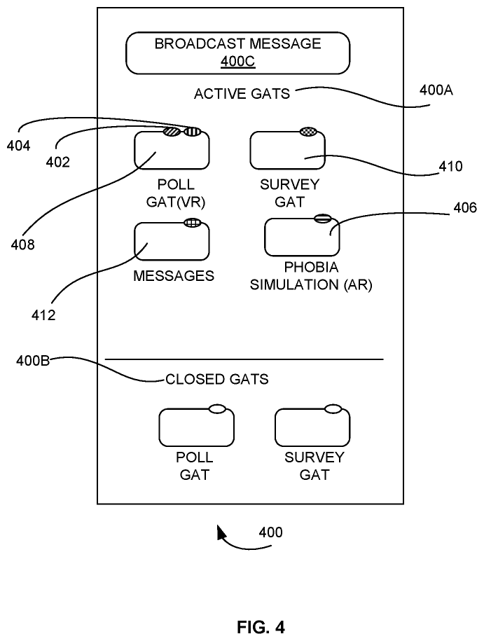

FIG. 4 illustrates an exemplary user interface view 400 of a user device for a group, according to some embodiments herein. The exemplary user interface view 400 displays active GATs 400A, a broadcast message field 400C, and closed GATs 400B. The broadcast messages 400C may display the messages sent by the first user 102A, thereby highlighting the first user's messages over the second user's messages. The active GATs include a poll GAT 408, messages GAT 412, phobia simulation using augmented reality (AR) GAT 406, and a survey GAT 410. The active group activity tool continues to remain active as long as the first user 102A does not close the group. In an embodiment, the first user 102A and the second user 102B may participate in the activities even after a due date has passed. A first notification badge 402 and a second notification badge 404 on a poll GAT 408 are color-coded based on due dates of the active GATs 400A. In some embodiments, the color-coded notification badges also showcase the number of notifications. The closed GATs 400B includes the GATs that are closed by the first user 102A, for example, poll, and survey. In some embodiments, the system 100 may also leverage a framework for immersive experience interfaces, such as augmented reality and virtual reality, and so on for enhanced group engagement.

In an exemplary embodiment, for depression treatment, a group is created by providing parameters like a group title, a group description, a group template identity, or a unique group identity. The group title may be “depression treatment—with Dr. John Doe”. The group description may be “the depression treatment therapy is focused on how to control depression in practical ways that can be used now and, in the future.” A GAT template is chosen from a GAT repository based on the first input. The GAT template repository includes one or more GAT templates. Based on the selected GAT template, a GAT is instantiated.

The generated GAT includes a question-and-answer model, for example, the question may be, “what is wrong with the following statements?”, for which the member of the group may pick one or more options as the answers. The options may be (1) I should be loved and approved by everyone (2) I should always be able to do things well and work hard all the time to feel good about myself (3) some people are bad and should be punished (4) I will feel awful if things don't go the way that I want to them to go (5) other people and things I cannot change make me unhappy (6) I should worry about bad things that could happen (7) I can never be happy if I don't want to have someone to love me (8) I can't change the way I am; I was raised this way (9) I just feel sad when people I care about are having bad times and (10) it will be awful if I don't do the right thing, The generated GAT may be converted as action GAT until the member of the group completes the action of choosing the option as answer for the provided question.

The following table 1 illustrates an exemplary GAT for a back depression inventory that requires action from the member of the group.

TABLE 1

Check thoughts you had today
Day 1
1. It will be fun doing such
and such this weekend
2. The weather is great today
3. I can do better than that
4. Life is interesting
5. I really feel great
6. This is fun
7. I am a good person

The following table 2 illustrates for ABCD method is another exemplary GAT that requires action from the member of the group.

TABLE 2

| | |
|---|---|
| A. Activating event (What | C. Consequence (How did you |
| happened?) | react?) |
| B. Belief about what happened | D. Disputing the belief |
| (What did you tell yourself | (alternative thoughts that |
| about what happened that | would help you in a healthier |
| influenced your reaction?) | manner) |

In some embodiments, the members of the group respond using the augmented reality (AR) interface or the virtual reality (VR) interface by capturing different action responses. For example, using VR the users are allowed to join sessions using a VR headset. The generated GATS in table 1 and table 2 are made interactive using VR. The questionnaire in generated GATs (table 1, table2) is shown in a real-time scenario using VR.

The AR sessions may be also used for a new level of interaction and engagement with the user. The real-time scenario for the questionnaire in generated GATs (table 1, table2) is created using AR by three-dimensional models on immediate surroundings viewed from all angles through the user device 104A.

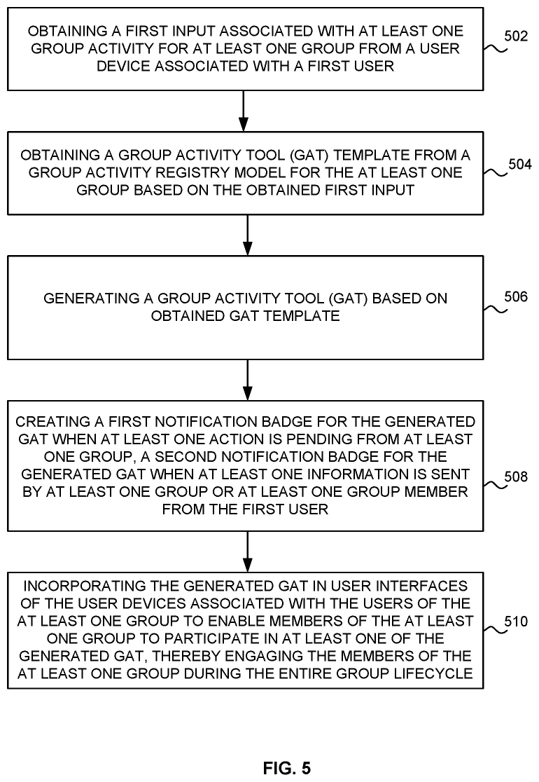

FIG. 5 illustrates a method for engaging an online group during an entire group lifecycle, according to some embodiments herein. At step 502, the method includes obtaining a first input associated with at least one group activity for at least one group from a first user device associated with a first user. In some embodiments, the first input includes at least one parameter related to the at least one group activity. At step 504, obtaining a group activity tool (GAT) template from a group activity tool template repository for the at least one group based on obtained first input. In some embodiments, the group activity tool template repository includes one or more GAT templates. At step 506, the method includes generating a GAT based on obtained GAT template and the first input. At step 508, the method includes creating a first notification badge, and a second notification badge on the generated GAT for the at least one group, the first notification badge indicates when at least one action related to the at least one group activity is pending from at least one group of the first user and the second notification badge is created when at least one information is sent by at least one group member of the at least one group. At step 510, the method includes incorporating the generated GAT in user interfaces of the user devices associated with members of the at least one group to enable the members of the at least one group to participate in the at least one group activity via the generated GAT, thereby engaging the members of the at least one group during the entire group lifecycle.

In some embodiments, the method further includes (i) obtaining the first input from the first user through a first interface of the first user device, the first input includes information to create a group, to close a group, to create a GAT, or to create broadcast messages, (ii) creating the at least one group based on the first input that includes a plurality of parameters. The plurality of parameters may include at least one of a group title, a group description, a group template identity, or a unique group identity.

In some embodiments, the method includes providing a separate interface for the first user to communicate with the at least one group by creating messages and broadcasting the messages in the separate, thereby separating the messages of the first user from other members of the at least one group to improve communication within the at least one group.

In some embodiments, the generated GAT includes at least one of group rules for the members, a link for an upcoming meeting, at least one of a poll for participation, instructions to upload a media content, or a questionnaire for participation.

In some embodiments, the first notification badge and the second notification badge are color-coded for easy identification. The first notification badge and the second notification badge may comprise a count of items in the generated GAT.

In some embodiments, the first notification badge and the second notification badge are displayed simultaneously with respective due dates for completing the at least one group activity. The color-coding of the first notification badge and the second notification badge may change based on the respective due dates.

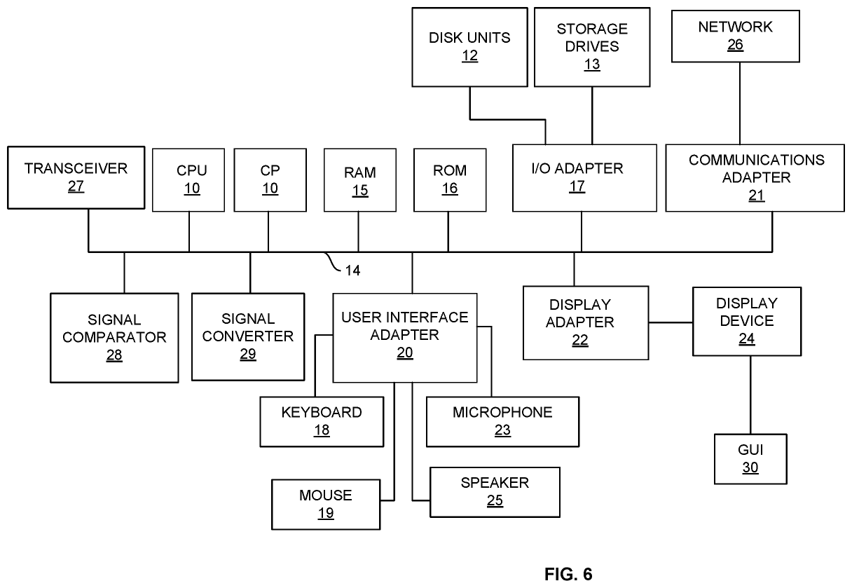

A representative hardware environment for practicing the embodiments herein is depicted in FIG. 6, with reference to FIGS. 1 through 5. This schematic drawing illustrates a hardware configuration of a system 100/a group activity server 106/user devices 104A-N/any computing device in accordance with the embodiments herein. The system includes at least one processing device (CPU) 10 that may be interconnected via system bus 14 to various devices such as a random-access memory (RAM) 12, read-only memory (ROM) 17, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus to a display device 27, which provides a graphical user interface (GUI) 37 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A processor-implemented method for engaging an online group during an entire group lifecycle using a group activity server that is communicatively connected with user devices associated with users, the method comprising:
obtaining a first input associated with at least one group activity for at least one group from a first user device associated with a first user, wherein the first input comprises at least one parameter related to the at least one group activity;
obtaining a group activity tool (GAT) template from a group activity tool template repository for the at least one group based on obtained first input, wherein the group activity tool template repository comprises a plurality of GAT templates;
generating a GAT based on obtained GAT template and the first input;
creating a first notification badge, and a second notification badge on the generated GAT for the at least one group, wherein the first notification badge indicates when at least one action related to the at least one group activity is pending from the at least one group of the first user and the second notification badge indicates when at least one information is sent by at least one group member of the at least one group; and
incorporating the generated GAT in user interfaces of the user devices associated with members of the at least one group to enable the members of the at least one group to participate in the at least one group activity via the at least one of the generated GAT, thereby engaging the members of the at least one group during the entire group lifecycle.

2. The processor-implemented method of claim 1, wherein the method further comprises
obtaining the first input from the first user through a first interface of the first user device, wherein the first input comprises information to create a group, to close a group, to create a GAT, or to broadcast messages; and
creating the at least one group based on the first input that comprises a plurality of parameters, wherein the plurality of parameters comprises at least one of a group title, a group description, a group template identity, or a unique group identity.

3. The processor-implemented method of claim 1, wherein the method comprises providing a separate interface for the first user to communicate with the at least one group by creating messages and broadcasting the messages in the separate interface, thereby separating the messages of the first user from other members of the at least one group to improve communication within the at least one group.

4. The processor-implemented method of claim 1, wherein the generated GAT comprises at least one of group rules for the members, a link for an upcoming meeting, at least one of a poll for participation, instructions to upload a media content, or questionnaire for participation.

5. The processor-implemented method of claim 1, wherein the first notification badge and the second notification badge are color-coded for easy identification, wherein the first notification badge and the second notification badge comprise a count of items in the generated GAT.

6. The processor-implemented method of claim 5, wherein the first notification badge and the second notification badge are displayed simultaneously with respective due dates for completing the at least one group activity, wherein the color-coding of the first notification badge and the second notification badge changes based on the respective due dates.

7. One or more non-transitory computer-readable storage mediums storing one or more sequences of instructions, which when executed by one or more processors, causes to perform a method for engaging an online group during an entire group lifecycle using a group activity server that is communicatively connected with user devices associated with users performing steps of:
obtaining a first input associated with at least one group activity for at least one group from a first user device associated with a first user, wherein the first input comprises at least one parameter related to the at least one group activity;
obtaining a group activity tool (GAT) template from a group activity tool template repository for the at least one group based on obtained first input, wherein the group activity tool template repository comprises a plurality of GAT templates;
generating a GAT based on obtained GAT template and the first input;
creating a first notification badge, and a second notification badge on the generated GAT for the at least one group, wherein the first notification badge indicates when at least one action related to the at least one group activity is pending from the at least one group of the first user and the second notification badge indicates when at least one information is sent by at least one group member of the at least one group; and
incorporating the generated GAT in user interfaces of the user devices associated with members of the at least one group to enable the members of the at least one group to participate in the at least one group activity via the at least one of the generated GAT, thereby engaging the members of the at least one group during the entire group lifecycle.

8. A system for engaging an online group during an entire group lifecycle using a group activity server that is communicatively connected with user devices associated with users, wherein the system comprises:
one or more user devices;
a group activity server that is communicatively connected with the one or more user devices, wherein the group activity server comprises
a memory that stores a database and a set of modules;
a processor in communication with the memory, the processor retrieving executing machine-readable program instructions from the memory which, when executed by the processor, enable the processor to:
obtain a first input associated with at least one group activity for at least one group from a first user device associated with a first user, wherein the first input comprises at least one parameter related to the at least one group activity:
obtain a group activity tool (GAT) template from a group activity tool template repository for the at least one group based on obtained first input, wherein the group activity tool template repository comprises a plurality of GAT templates;
generate a GAT based on obtained GAT template and the first input;
create a first notification badge, and a second notification badge on the generated GAT for the at least one group, wherein the first notification badge indicates when at least one action related to the at least one group activity is pending from the at least one group of the first user and the second notification badge indicates when at least one information is sent by at least one group member of the at least one group; and
incorporate the generated GAT in user interfaces of the user devices associated with members of the at least one group to enable the members of the at least one group to participate in the at least one group activity via the at least one of the generated GAT, thereby engaging the members of the at least one group during the entire group lifecycle.

9. The system of claim 8, wherein the processor is configured to,
obtain the first input from the first user through a first interface of the first user device, wherein the first input comprises information to create a group, to close a group, to create a GAT, or to broadcast messages,
create the at least one group based on the first input that comprises a plurality of parameters, wherein the plurality of parameters comprises at least one of a group title, a group description, a group template identity, or a unique group identity.

10. The system of claim 8, wherein the processor is configured to provide a separate interface for the first user to communicate with the at least one group by creating messages and broadcasting the messages in the separate interface, thereby separating the messages of the first user from other members of the at least one group to improve communication within the at least one group.

11. The system of claim 8, wherein the generated GAT comprises at least one of group rules for the members, a link for an upcoming meeting, at least one of a poll for participation, instructions to upload a media content, or questionnaire for participation.

12. The system of claim 8, wherein the first notification badge and the second notification badge are color-coded for easy identification, wherein the first notification badge and the second notification badge comprise a count of items in the generated GAT.

13. The system of claim 8, wherein the first notification badge and the second notification badge are displayed simultaneously with respective due dates for completing the at least one group activity, wherein the color-coding of the first notification badge and the second notification badge changes based on the respective due dates.
